(19) United States
(12) Patent Application Publication
(10) Pub. No.: US 2003/0235489 A1
(43) Pub. Date: Dec. 25, 2003

(54) Load control system for tandem pallet truck

(76) Inventor: William H. Hoff, Tillsonburg (CA)

Correspondence Address: QUARLES & BRADY LLP, 411 E. WISCONSIN AVENUE, SUITE 2040, MILWAUKEE, WI, 53202-4497, US

(21) Appl. No.: 10/178,387

(22) Filed: Jun. 24, 2002

(51) Int. Cl. B65G 1/00

(52) U.S. Cl. 414/607

(57) ABSTRACT

A tandem pallet truck includes a sensor for determining when a first load or pallet has been placed on a load bearing fork. The lifting capacity of the forks is maintained at a first level until a first pallet is detected. The lifting capacity of the forks is then increased to accept a second pallet, thereby preventing overload of the forks.

### FIELD OF THE INVENTION

The present invention relates to material handling vehicles and, more particularly, to a control system for adjusting the lift capacity of a tandem pallet truck.

### BACKGROUND OF THE INVENTION

Industrial material handling vehicles such as a lift trucks or pallet trucks are commonly found in warehouses, factories, shipping yards, and, generally, wherever pallets, packages, or loads of goods are required to be moved from place to place. Lift or pallet trucks typically include a load bearing fork or lift arm driven by a fluid power or hydraulic circuit. The fluid power or hydraulic circuit is powered by a storage battery, generally contained in a housing of the pallet truck.

In warehousing and other package delivery applications, it is generally desirable to move as many packages as possible, in as little time as possible, and with a minimal amount of labor, such that packages or pallets can be delivered with a high degree of efficiency. To meet these goals, tandem pallet trucks have been developed. Tandem pallet trucks are constructed with relatively long forks or lift arms which are capable of receiving two or more pallets, thereby increasing the amount of goods which can be delivered in a single load, by a single operator.

While tandem pallet trucks are therefore desirable to improve efficiency and flexibility of delivery operations, there are a number of problems associated with these vehicles. For example, the forks and the associated hydraulic circuitry are typically designed to operate at a rated load, calculated to be evenly distributed along the entire length of the forks. The operating pressure of the hydraulic circuit, likewise, is calculated to lift the rated load. Tandem pallet trucks, however, are often operated while carrying only a single pallet or load. If the weight of the single pallet or load is less than the expected rated load, the hydraulic circuit can provide sufficient force to lift the pallet. However, as the single load is concentrated in a portion of the fork as opposed to distributed along the length of the fork, the forks are typically insufficiently strong to handle the single pallet, and can be bent or damaged while trying to lift the pallet. Such damage results in significant expense, requiring both costly repairs and vehicle “down time”, during which the use of the pallet truck is lost.

Furthermore, because tandem pallet trucks are operated at a pressure calculated to lift a tandem load even when unloaded or carrying a single load, the hydraulic circuit is continually operated at a higher pressure than necessary. Operation at high pressure levels consumes a significant amount of energy, depleting the energy storage in the battery, and also causes seals, hoses and other components of the hydraulic system to wear quickly. All of these components, therefore, must be monitored and maintained frequently to avoid vehicle failure and down time.

Therefore, although tandem pallet trucks can offer a significant advantage in terms of load capacity, typical hydraulic circuits for use in tandem pallet trucks are expensive to operate, prone to failure, and insufficiently sophisticated to prevent expensive damage to the forks of the vehicle. All of these problems decrease the efficiency of warehousing operations, specifically by increasing maintenance “down” time, and therefore increasing operational cost.

For at least these reasons, there remains a need for a tandem pallet truck which can be automatically configured to handle a single or a tandem pallet load. The tandem pallet truck and associated hydraulic circuit of the present invention provides this benefit.

### SUMMARY OF THE INVENTION

The present invention is a pallet truck which includes a sensor coupled to the load bearing fork. The sensor produces a load control signal when a first pallet is placed on the load bearing fork. A drive mechanism receives the load control signal from the sensor and increases the load capacity of the forks in response to the load control signal.

A general object of the invention is to provide a control circuit for a pallet truck which increases the load lift capacity of the truck when a first pallet is placed on the forks. The circuit includes a sensor for detecting a first pallet placed on the load bearing fork, and a fluid power circuit comprising a control valve coupled to the sensor to receive a load control signal indicating that the first pallet has been detected. The control valve is coupled to first and second pressure relief valves, where the first pressure relief valve produces a lower operational pressure than the second pressure relief valve. The control valve selectively couples the second pressure relief valve to the fluid power circuit to increase the pressure of the circuit in response to the load control signal, thereby increasing the load lift capacity of the load bearing fork when the first pallet is on the load bearing fork.

Another object of the invention is to provide a pallet sensor for sensing the presence of the pallet on the fork. The pallet sensor comprises a switch and one or more springs coupled between a moveable detector plate and the fork. The force of the spring is selected to prevent accidental tripping of the switch until a pallet of a selected size is detected.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a perspective view of a pallet truck;

FIG. 2 is a partial side view of the pallet truck of FIG. 1 illustrating the forks of the pallet truck;

FIG. 3 is a cutaway view of a fork illustrating a pallet sensor constructed in accordance with the present invention; and

FIG. 4 is a circuit diagram of a hydraulic circuit constructed in accordance with the present invention; and

FIG. 5 is an electrical diagram of the interconnection between the pallet sensor of FIG. 3 and the hydraulic circuit diagram of FIG. 4.

### DETAILED DESCRIPTION OF THE PREFERRED EMBODIMENT

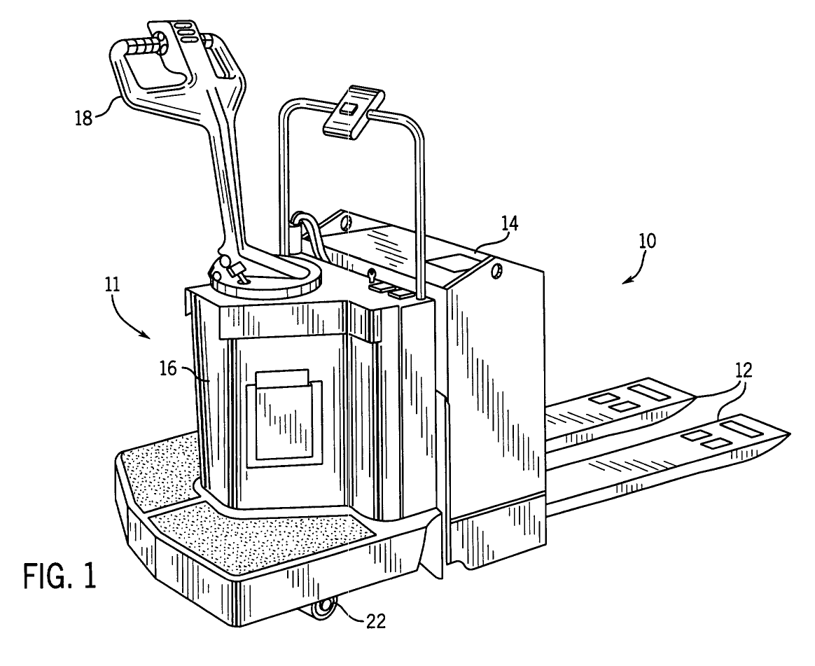

Referring now to the figures and more particularly to FIG. 1 a pallet truck 10 constructed in accordance with the present invention is shown. The pallet truck 10 comprises one or more load bearing forks or lift arms 12, a steering mechanism 18, and a housing 11 including both a battery housing 14 and a motor housing 16. The steering mechanism 18 is coupled to a steerable wheel 22 located beneath the housing 16 which directs the motion of the truck 10, and to a drive mechanism coupled to the lead bearing forks 12, and located within the motor housing 16. The drive mechanism preferably comprises a fluid power or hydraulic circuit 38 which lifts or lowers the bearing forks 12 in response to commands from the steering mechanism 18. The load bearing forks 12 include a pallet sensor 28 which is activated to provide a load control signal to the hydraulic circuit 38 when a first pallet is positioned on the load bearing fork 12 as described below.

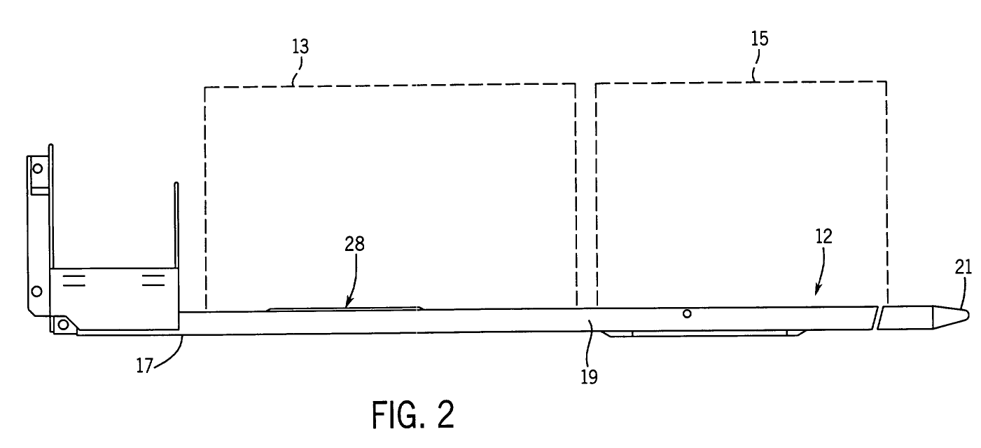

Referring now to FIG. 2, a partial side view of the pallet truck 10 illustrating a load bearing fork 12 including a pallet sensor 28 is shown. The load bearing forks 12 are sized and dimensioned to receive first and second pallets 13 and 15 in tandem on the pallet truck 10, the first pallet 13 being positioned on the fork 12 in a location adjacent the housing 11, and the second pallet 15 being positioned on the fork 12 adjacent the first pallet 13, near the distal end 21 of the fork 12. The pallet sensor 28 is located on the load bearing fork 12 in a position relatively near the housing 11 of the pallet truck 10 to detect the presence of the first pallet 13. Preferably, the pallet sensor 28 is positioned on the fork 12 between a back end of the fork 17 and a midpoint 19 of the fork halfway between the back end 17 and tip 21 of the fork 12. The sensor 28 is therefore positioned to detect the pallet positioned on the half of the fork 12 closest to the housing 11.

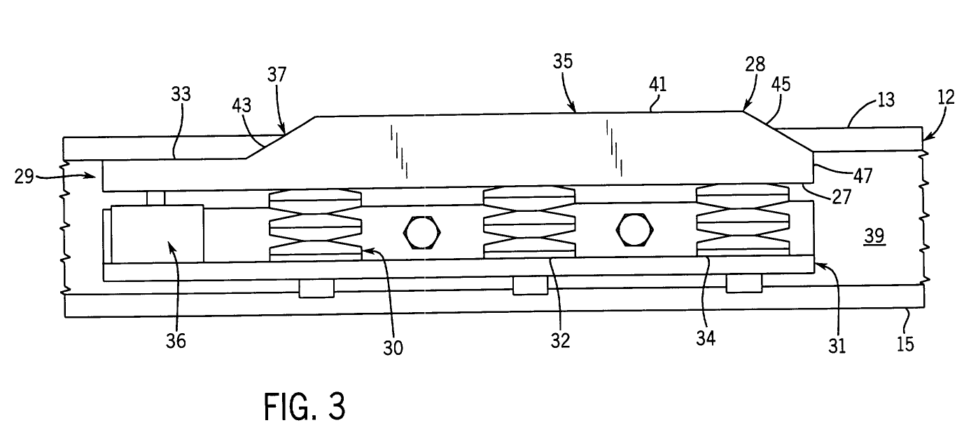

Referring now to FIG. 3 a cutaway side view of the bearing fork 12 and the pallet sensor 28 is shown. The bearing fork 12 includes a top plate 13 and a bottom plate 15, which are horizontally offset to provide a space 39 in the fork 12. The sensor 28 is received in the space 39, and extends through an aperture 37 provided in the top plate 13, as described below.

Referring still to FIG. 3, the pallet sensor 28 includes a moveable detector plate 29; a stationary plate 31; a plurality of springs 30, 32, and 34; and a switch 36. The moveable detector plate 29 includes a generally planar bottom surface 27, and a top surface 25 which includes both a planar base section 33 and a plateau section 35. The plateau section 35 includes a generally flat upper surface 41 and two angled side surfaces, 43 and 45, the angled side surface 43 extending upward from the base section 33 to the flat upper section 41, and the angled side surface 45 extending downward from the flat upper section 41 to a side end 47 of the detector plate 29. The stationary plate 31 is generally planar on both sides.

The stationary plate 31 is disposed in the space 39 in the fork 12 and is coupled to the bottom plate 15 of the fork 12, such that the stationary plate 31 is substantially parallel to the bottom plate 15. The moveable detector plate 29 is positioned in the space 39 such that the plateau section 35 extends through the aperture 37, where it is accessible to a pallet placed on the fork 12. The springs 30, 32, and 34 are coupled between the stationary plate 31 and the moveable detector plate 29, and positioned under the plateau section 35, providing a counteractive force on a pallet or load placed on the sensor 28, as described below. The base section 33 of the moveable detector plate 29 is positioned under the top plate 13 of the fork 12 adjacent the aperture 37, and is positioned above the switch 36 such that, as the moveable detector plate 29 is forced down by a pallet, the switch 36 is activated.

As noted above, in operation, the springs 30, 32, and 34 provide a counteractive force against a pallet, load or other weight placed on the pallet sensor 28. The counteractive force defines a lower weight limit which a load placed on the fork 12 must exceed in order to force the detector plate 29 down to trip the switch 36. The counteractive force of the springs 30, 32, and 34 prevents accidental tripping of the switch 36, and is preferably selected to prevent activation of the switch 36 by an operator stepping on or otherwise tripping the sensor 28, thereby substantially defeating attempts to manually override the sensor 28.

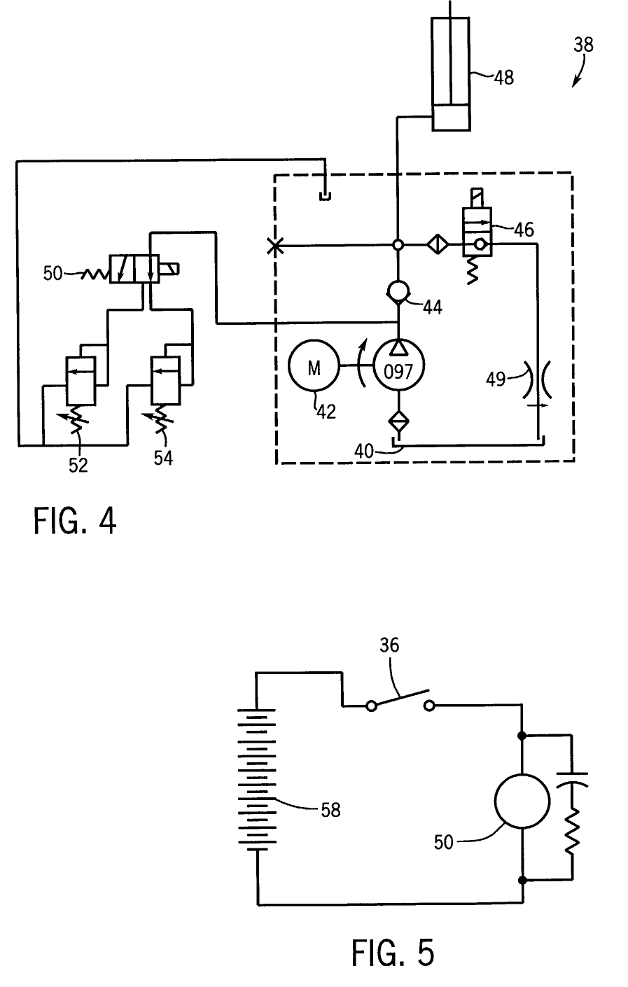

Referring now to FIG. 4 a circuit diagram of the fluid power or hydraulic circuit 38 employed as a drive mechanism to control the lifting and lowering of the forks 12 is shown. The hydraulic circuit 38 generally comprises a pump 42, directional control valve 46, and a cylinder 48. The cylinder 48 is coupled to the forks 12 in a conventional manner, and the pump 42 and directional control valve 46 drive the forks 12 up or down, depending on the direction of motion selected at the steering mechanism 18, also in a conventional manner. An orifice or flow valve 49 limits the speed at which the forks 12 can be lowered to assure a smooth lifting and lowering motion for the forks 12.

Referring now to FIGS. 4 and 5, the pressure of the fluid in the hydraulic circuit 38 is controlled by pressure relief valves 52 and 54. The pressure relief valves 52 and 54 are coupled to the hydraulic circuit 38 through a control valve 50 which is selectively activated by the switch 36 in the pallet sensor 28, depending on whether a first pallet 13 has been received on the pallet sensor 28. When the switch 36 is in the off state and a first pallet is not present on the fork 12, the pressure relief valve 54 controls the pressure in the circuit 38. The pressure relief valve 54 is selected to have a lower operating pressure than that of the second relief valve 52 and preferably to have a pressure of half that of the second relief valve 52. Therefore, if a single pallet 15 is placed on the forks 12, the amount of weight which can be lifted is limited by the pressure relief valve 54 to a lesser amount than can be lifted if first and second pallets 13 and 15 are distributed along the length of the forks. When the switch 36 is activated, a voltage from the battery 58 is applied to the control valve 50, which switches the pressure relief valve 54 out of the hydraulic circuit 38 and the pressure relief valve 52 into the hydraulic circuit 38, thereby increasing the overall lift capacity of the circuit by increasing the pressure of the fluid in the circuit 38 as required to lift the second pallet 15 on the fork 12.

Therefore, when operated with the hydraulic circuit of FIG. 4, a number of advantages are achieved. First, when the pallet truck 10 is operated without a load, the hydraulic circuit 38 operates at a reduced pressure, thereby reducing the amount of energy required to drive the hydraulic circuit 38, and increasing the life of the storage battery 58 that drives the circuit 38. Second, because the hydraulic circuit 38 is generally operating at a lower pressure, the total amount of pressure applied to the seals, hoses, and other components of the hydraulic circuit is reduced, thereby decreasing the frequency of maintenance. Additionally, because the pressure is low if a first pallet 13 is not positioned on the half of the fork closest to the housing 11, proper loading of the forks 12 is assured. Furthermore, the hydraulic circuit 38 prevents lifting of a single heavy load positioned at the end of the fork which might damage or bend the forks 12.

In a preferred embodiment of the invention, the forks 12 are sized and dimensioned to receive a load of 8000 pounds. In this embodiment, the lift cylinder has a two inch bore, the pressure relief valve 54 is rated at fifteen hundred pounds per square inch (PSI) while the pressure relief valve 52 is rated at three thousand PSI. The pressure relief valves are sized and dimensioned based on the size of the lifting cylinder and the rated load and can be varied depending on these parameters.

It should be understood that the methods and apparatuses described above are only exemplary and do not limit the scope of the invention, and that various modifications could be made by those skilled in the art that would fall under the scope of the invention. For example, while a single pallet sensor has been shown and described, it will be apparent that a number of sensors could be inserted into the forks to more fully characterize the load on the forks. In such a system, a corresponding number of pressure relief valves could be added to the hydraulic circuit. Additionally, while a specific type of pallet sensor device has been shown and described, it will be apparent that various types of switching devices can be similarly employed. Furthermore, various methods could be used to establish a “trip” limit for the switching device, including sensors which determine the amount of weight applied to the fork. Also, while a preferred embodiment has been shown and described, the method of the present invention can be applied to pallet trucks designed for handling loads of varying weights. To apprise the public of the scope of this invention, the following claims are made:

1. A pallet truck, comprising:
a load bearing fork, the load bearing fork being sized and dimensioned to receive a load;
a sensor coupled to the load bearing fork, the sensor producing a load control signal when a load is placed on the load bearing fork; and
a drive mechanism coupled to the load bearing fork for raising and lowering the fork, and being operable in response to the load control signal received from the sensor to increase its load lifting capacity, whereby the drive mechanism is operable at a low load lifting capacity when a load is not being carried on the load bearing fork.

2. The pallet truck as defined in claim 1, wherein the drive mechanism comprises a fluid power circuit including:
a drive cylinder coupled to the load bearing fork to drive the fork up and down;
a control valve coupled to the load detection device to receive the load signal; and
first and second pressure relief valves coupled to the control valve, the control valve selectively coupling the first or the second pressure relief valve to the drive cylinder to adjust the load lift capacity in response to the load control signal.

3. The pallet truck as defined in claim 1, further comprising a fork control mechanism providing a fork control signal to the drive mechanism to raise or lower the fork in response to a command from an operator.

4. The pallet truck as defined in claim 1, wherein the sensor comprises:
a detector plate extending from an aperture in the fork for detecting a load placed on the fork; and
a switch coupled between the detector plate and the fork, the switch producing the load signal when the load is placed on the detector plate to activate the switch.

5. The pallet truck as defined in claim 4, wherein the sensor further comprises:
a spring coupled between the detector plate and a bottom of the fork, the spring being sized and dimensioned to provide a counteractive force against the detector plate to provide a minimum weight limit to trip the switch.

6. The pallet truck as defined in claim 1, wherein the first pressure relief valve provides a pressure of substantially half of the magnitude of a pressure of the second relief valve.

7. The pallet truck as defined in claim 1, further comprising a storage battery for providing electrical power to the electrical and hydraulic circuit components.

8. The pallet truck as defined in claim 1, wherein:
the fork comprises a tip end and a back end; and
the detector is disposed on the fork between the back end and a midpoint half way between the back end and the tip end.

9. A control circuit for controlling a lifting capacity of a load bearing fork of a pallet truck, the control circuit comprising:
a sensor coupled to the load bearing fork, the sensor producing a load control signal when a pallet is placed on the load bearing fork; and
a fluid power circuit including
a fluid cylinder coupled the load bearing fork to drive the fork up and down;
a first pressure relief valves coupled to the fluid cylinder to provide a first operational pressure to the fluid cylinder;
and second pressure relief valves coupled to the fluid cylinder to provide a second operational pressure which is lower than the first operational pressure to the fluid cylinder; and
a control valve coupled to the sensor to first and second pressure relief valves and being operable in response to the load control signal to increase the load lift capacity of the load bearing fork when the pallet is on the load bearing fork.

10. The control circuit as defined in claim 9, wherein the sensor comprises an electrical switch.

11. The control circuit as defined in claim 9, wherein the sensor further comprises:
a detector plate extending upward from the load bearing fork; and
a spring coupled between the detector plate and a bottom of the load bearing fork; and
a switch coupled between the detector plate and the bottom of the load bearing fork, wherein the spring provides a minimum weight which must be applied to the detector plate to activate the switch.

12. The control circuit as defined in claim 11, wherein the sensor is coupled to a load bearing fork sized and dimensioned to receive a tandem load.

13. The control circuit as defined in claim 11, wherein a pressure produced by the first pressure relief valve is twice the pressure produced by the second pressure relief valve.

14. The control circuit as defined in claim 9, further comprising:
a directional control valve coupled to the control valve to switch the direction of fluid flow to raise or lower the forks.

15. The control circuit as defined in claim 9, wherein the fluid is a hydraulic fluid.

16. A tandem pallet truck, comprising:
a load bearing fork, the load bearing fork being sized and dimensioned to receive a first and a second pallet;
a pallet sensor coupled to the load bearing fork, the pallet sensor comprising:
a switch coupled to the fork to detect a pallet placed on the fork, and providing a control signal indicating that a pallet has been placed on the fork;
a spring, coupled in parallel with the switch, the spring providing a counteractive force establishing a weight limit that the pallet must exceed to trip the switch; and
a fluid power circuit, the fluid power circuit comprising
a control valve, electrically connected to the switch to receive the control signal;
and first and second pressure relief valves coupled to the control valve, the control valve selectively coupling the first or the second pressure relief valve to the fluid power circuit to adjust the pressure in the circuit when the switch is activated.

17. The pallet truck as defined in claim 16, wherein the fluid power circuit further comprises a drive cylinder coupled to the load bearing fork.

18. The pallet truck as defined in claim 16, wherein the electrical power source is a storage battery.

19. The pallet truck as defined in claim 16, wherein the storage battery powers the pallet truck.

20. The pallet truck as defined in claim 16, wherein the pallet sensor is disposed in an aperture in the fork.
